(19) United States
(12) Patent Application Publication
(10) Pub. No.: US 2008/0253693 A1
(43) Pub. Date: Oct. 16, 2008

(54) METHOD AND SYSTEM FOR PRE-FETCHING RELEVANT IMAGING INFORMATION FROM MULTIPLE HEALTHCARE ORGANIZATIONS

(76) Inventors: Jeff I. Chu, Buffalo Grove, IL (US); Anuj Kumar, Bokaro Steel City (IN); Priya Balvant Padate, Palatine, IL (US)

Correspondence Address: MCANDREWS HELD & MALLOY, LTD, 500 WEST MADISON STREET, SUITE 3400, CHICAGO, IL, 60661, US

(21) Appl. No.: 11/733,328

(22) Filed: Apr. 10, 2007

(51) Int. Cl. G06K 9/00; G06K 9/54; G06K 9/60

(52) U.S. Cl. 382/305; 382/128

(57) ABSTRACT

Certain aspects of a method and system for pre-fetching relevant imaging information from multiple healthcare organizations is disclosed. Aspects of one method may include querying data associated with one or more patients from a shared document registry. The method includes receiving manifests of imaging data associated with one or more patients from a shared document repository based on the queried data. The method also includes pre-fetching imaging data associated with one or more patients from a shared imaging data repository based on the received manifests of the imaging data. The method further includes storing the pre-fetched imaging data in an image storage repository within a picture archiving and communication system (PACS). The stored imaging data may be accessed by a user via one or more PACS work stations.

### CROSS-REFERENCE TO RELATED APPLICATIONS

[Not applicable]

### FEDERALLY SPONSORED RESEARCH OR DEVELOPMENT

[Not applicable]

### MICROFICHE/COPYRIGHT REFERENCE

[Not applicable]

### FIELD OF THE INVENTION

Certain embodiments of the invention relate to pre-fetching relevant imaging information. More specifically, certain embodiments of the invention relate to a method and system for pre-fetching relevant imaging information from multiple healthcare organizations.

### BACKGROUND OF THE INVENTION

Documents and data representing a patient's medical record may be generated and archived on a variety of systems over the course of diagnosis and treatment. A number of imaging and clinical activities may benefit from a coordinated method for sharing, locating and accessing relevant imaging related documents. Images, diagnostic reports, and evidence documents derived from the processing of images may represent important components of a patient's medical record. These imaging documents may be managed and archived on a variety of imaging information systems such as a radiology information system (RIS) and a picture archiving and communication system (PACS) over the course of diagnosis and treatment.

For example, for a particular patient, some of this imaging information may be produced in departments associated with one or more in-patient facilities, where the patient may have been hospitalized, as well as independent imaging centers. A number of healthcare delivery professionals, for example, referring physicians, radiologists, surgeons, and oncologists may benefit from a coordinated method for locating and accessing relevant imaging information. The creation and subsequent usage of these documents may span several care delivery organizations and may be performed separately over different time periods.

The Integrating the Healthcare Enterprise (IHE) IT infrastructure developed the cross-enterprise document sharing (XDS) profile to provide an integrated solution to the problem of general purpose document sharing in a broad health care environment. The XDS profile specifies sharing of imaging documents such as radiology images and reports. The cross-enterprise document sharing for imaging (XDS-I) profile is an extension of the XDS profile and enables sharing, locating and accessing digital imaging and communications in medicine (DICOM) instances from its original local sources, for example, for radiologists or oncologists. The information to be shared may include imaging studies that include images acquired on a broad range of different modalities as well as evidence documents, for example, post-processing measurements, and presentation states. The imaging information may also include diagnostic reports or a selection of diagnostically significant images associated with a particular modality.

As medical technology becomes more sophisticated, clinical analysis and imaging related information may also become more sophisticated. Increasing amounts of data are generated and archived electronically. With the advent of clinical information systems, a patient's history may be available at a touch of a button. While accessibility of information is advantageous, time is a scarce commodity in a clinical setting. To realize a full benefit of medical technological growth, there is a need for clinical information to be organized and standardized.

For example, radiologists may frequently need to access historical exams of a patient when making diagnoses on new radiology exams. A user may be enabled to fetch historical exams of a patient from a long-time archive (LTA) of a local PACS so that they are immediately displayable when a new exam is read. However, when a patient has received healthcare services from multiple healthcare organizations, prior exams of the patient may not be available at the LTA of the local PACS. Radiologists typically read images on tight schedules and may not be able to wait for image retrievals of prior exams. There is a need for pre-fetching image related information from one or more healthcare organizations to reduce wait times for image retrievals and to increase the efficiency of medical professionals.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and system for pre-fetching relevant imaging information from multiple healthcare organizations is disclosed, substantially as shown in and/or described in connection with at least one of the figures, and as set forth more completely in the claims.

Certain embodiments provide a method for querying data associated with one or more patients from a shared document registry. The method includes receiving manifests of imaging data associated with one or more patients from a shared document repository based on the queried data. The method also includes pre-fetching imaging data associated with one or more patients from a shared imaging data repository based on the received manifests of the imaging data. The imaging data associated with one or more patients may comprise, for example, X-ray images, magnetic reasonance imaging (MRI) data, computer tomography (CT) imaging data, and other medical imaging data. The method further includes storing the pre-fetched imaging data in an image storage repository within a picture archiving and communication system (PACS).

Certain embodiments provide a PACS for accessing imaging information from one or more healthcare organizations. The PACS may comprise a query engine for querying data associated with one or more patients from a shared document registry. The PACS may also comprise a processing engine for receiving manifests of imaging data associated with one or more patients based on the queried data from a shared document repository. The PACS may further comprise a pre-fetching engine for pre-fetching the imaging data associated with one or more patients from a shared imaging data repository based on the received manifests of the imaging data. The PACS may further comprise an image storage repository for storing the pre-fetched imaging data.

Certain embodiments provide a method for pre-fetching imaging data associated with one or more patients from a shared imaging data repository based on a set of selection criteria. The selection criteria may include one or more of: a modality, a procedure, a body part, and/or a time period. The method also includes storing the pre-fetched imaging data in an image storage repository.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 illustrates an exemplary picture archiving and communication system (PACS), in accordance with an embodiment of the invention.

FIG. 2 is a block diagram of an exemplary PACS utilized for pre-fetching relevant imaging information from multiple healthcare organizations, in accordance with an embodiment of the invention.

FIG. 3 is a flow chart illustrating exemplary steps for pre-fetching imaging information from multiple healthcare organizations, in accordance with an embodiment of the invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

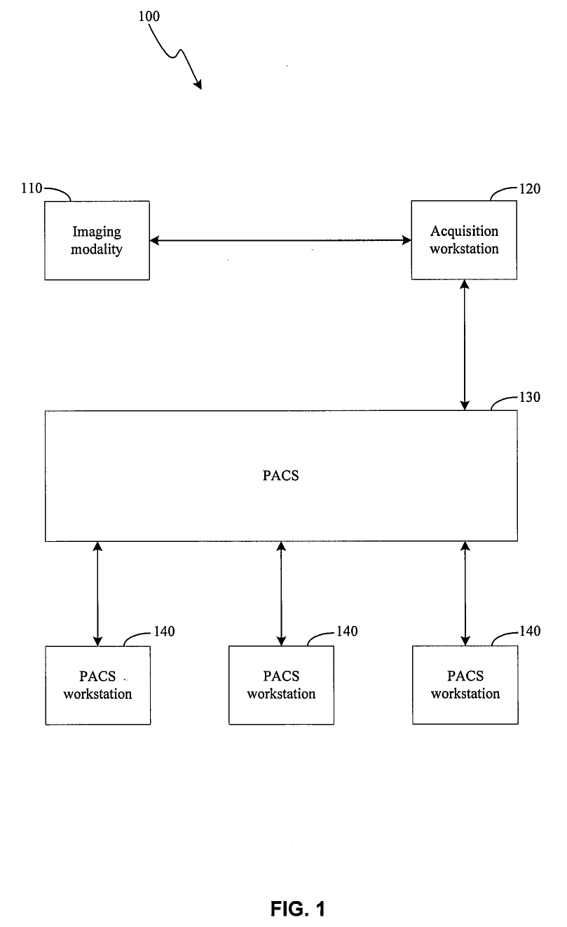

FIG. 1 illustrates an exemplary picture archiving and communication system (PACS), in accordance with an embodiment of the present invention. Referring to FIG. 1, there is shown a PACS system 100. The PACS system 100 may include one or more imaging modalities 110, acquisition workstations 120, PACS 130 and PACS workstations 140 and may not be limited to the embodiment of PACS system 100 illustrated in FIG. 1. The components of the PACS system 100 may communicate via wired and/or wireless communication, for example, and may be separate systems and/or integrated to varying degrees, for example.

In operation, the imaging modality 110 may be enabled to obtain one or more images of a patient's anatomy. The imaging modality 110 may include any device capable of capturing an image of a patient's anatomy such as a medical diagnostic imaging device. For example, the imaging modality 110 may include an X-ray imager, ultrasound scanner, magnetic resonance imager, or the like. An imaging data representative of the image(s) may be communicated between the imaging modality 110 and the acquisition workstation 120. The imaging data may be communicated electronically over a wired or wireless connection, for example.

In an embodiment, the acquisition workstation 120 may apply one or more preprocessing functions, for example, to the imaging data in order to prepare the image for viewing on a PACS workstation 140. For example, the acquisition workstation 120 may convert raw imaging data into a DICOM standard format or attach a DICOM header. The preprocessing functions may be characterized as modality-specific enhancements, for example, contrast or frequency compensation functions specific to a particular X-ray imaging device may be applied at the beginning of an imaging and display workflow. The preprocessing functions may differ from processing functions applied to imaging data in that the processing functions may not be modality specific but may be applied at the end of the imaging and display workflow, for example, at a display workstation 140. The imaging data may then be communicated between the acquisition workstation 120 and the PACS 130. The imaging data may be communicated electronically over a wired or wireless connection, for example.

The PACS 130 may include computer-readable storage media suitable for storing the imaging data for later retrieval and viewing at a PACS workstation 140. The PACS 130 may also include one or more software applications for additional processing and/or preprocessing of the imaging data by one or more PACS workstations 140.

One or more PACS workstations 140 may be capable of or may be configured to communicate with the PACS 130. The PACS workstations 140 may include a general purpose processing circuit, a PACS 130 interface, a software memory, and/or an image display monitor, for example. The PACS 130 interface may be implemented as a network card connecting to a TCP/IP based network, but may also be implemented as a parallel port interface, for example.

The PACS workstations 140 may also be capable of or may be configured to apply processing functions to imaging data. For example, a user may desire to apply processing functions to enhance features within an image representative of the imaging data. The processing functions may therefore adjust an image of a patient's anatomy in order to ease a user's diagnosis of the image. Such processing functions may include any software-based application that may alter a visual appearance or representation of imaging data. For example, a processing function may include any one or more of flipping an image, zooming in on an image, panning across an image, altering a window and/or level in a grayscale representation of the imaging data, and altering a contrast and/or brightness of an image.

The PACS workstations 140 may retrieve or receive imaging data from the PACS 130 for display to one or more users. For example, a PACS workstation 140 may retrieve or receive imaging data representative of a computed radiography image of a patient's chest. A radiologist may then examine the image as displayed on a display device for any objects of interest, for example, tumors or lesions.

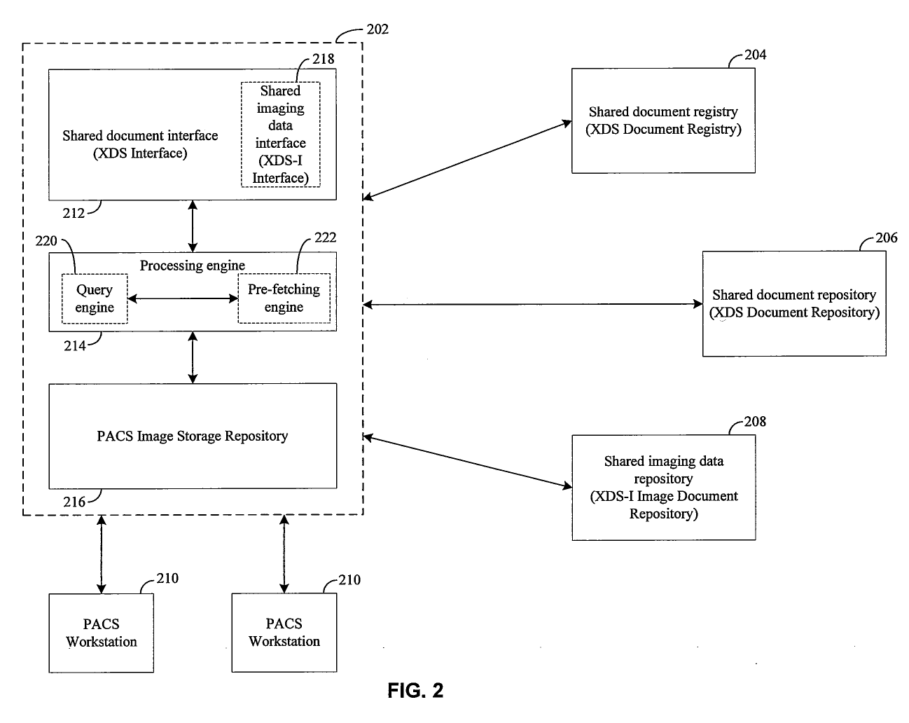

FIG. 2 is a block diagram of an exemplary PACS utilized for pre-fetching relevant imaging information from multiple healthcare organizations, in accordance with an embodiment of the invention. Referring to FIG. 2, there is shown a PACS 202 that is communicatively coupled to a shared document registry, for example, a cross-enterprise document sharing (XDS) document registry 204, a shared document repository, for example, a XDS document repository 206, a shared imaging data repository, for example, a cross-enterprise document sharing for imaging (XDS-I) image document repository 208, and a plurality of PACS workstations 210. The PACS 202 comprises a shared document interface, for example, a XDS interface 212, a processing engine 214, and a PACS image storage 216. The XDS interface 212 may comprise a shared imaging data interface, for example, a XDS-I interface 218 to handle imaging information. The processing engine 214 may comprise a query engine 220 and a pre-fetching engine 222.

The PACS 202 may be enabled to provide a single point of access for patient-related document and imaging information. The PACS 202 may also interface with existing hospital information systems, for example, hospital information system (HIS) and radiology information system (RIS) to provide a more consistent and reliable dataset. The PACS 202 may also be enabled to retrieve imaging information relevant to a particular patient based on, for example, patient name, patient number, and/or accession number for upcoming cases and present the retrieved imaging information to a technologist. The PACS 202 may be enabled to compare embedded imaging data with a list of scheduled studies from RIS, and flag a warning, if the imaging data does not match with a scheduled study, for example. The PACS 202 may also be enabled to pre-fetch imaging information from storage devices, for example, the long-time archive (LTA), tape libraries or local hard disk drives and store the pre-fetched imaging information onto online disk storage such as a redundant array of inexpensive disks (RAID) array.

In operation, document sharing may be facilitated by the PACS 202 integrated with the shared document interface, for example, the XDS interface 212. Patient data may be passed from one or more sources using an interface standard, such as the Health Level Seven (HL7) and/or Digital Imaging and Communications in Medicine (DICOM) communication interface and file format standards. The IHE has developed several integration profiles for sharing patient care information among multiple healthcare organizations to facilitate cross-enterprise interoperability. For example, the XDS-I profile combined with the XDS integration profile may facilitate sharing of imaging related documents among participating healthcare enterprises. A participant organization may determine the availability of images of a patient that are sharable from other healthcare enterprises and fetch those images to local storage.

In certain embodiments, the shared document interface, for example, the XDS interface 212 may be enabled by an XDS profile and/or protocol, such as an Integrating the Healthcare Enterprise Cross-Enterprise Sharing of Medical Summaries (IHE XDS-MS) integration profile or protocol to define a coupling or connection between one or more entities for patient document sharing. For example, the XDS interface 212 coupled with the processing engine 214 may be enabled to form a query, identifying sources with information about a particular patient and/or other criteria, determining an identifier used to associate clinical data related to the patient and/or other criteria, and request patient information from the appropriate source, such as the XDS document registry 204.

In certain embodiments, the shared imaging data interface, for example, the XDS-T interface 218 may be enabled by an XDS-I profile and/or protocol. The XDS-I interface 218 coupled with the processing engine 214 may be enabled to query imaging information associated with one or more patients from the shared document registry, for example, the XDS document registry 204 based on a set of selection criteria. For example, a PACS 202 user may query imaging information for the previous three months for a particular patient. In another embodiment, a PACS 202 user may query four most recent exams for a particular modality of the scheduled exam from the XDS document registry 204, for example.

In certain embodiments, the query engine 220 may be enabled to receive query information using an interface standard, such as the X.12 and/or National Council for Prescription Drug Programs (NCPDP) communication standard. The query engine 220 may serve as a message hub and/or switch to route query messages to one or more shared document repositories, for example, a XDS document repository 206. In an embodiment, the query engine 220 may be enabled to query data associated with one or more patients from the shared document registry, for example, the XDS document registry 204.

In certain embodiments, the shared document registry, for example, the XDS document registry 204 may be enabled to acknowledge the queried data associated with one or more patients by communicating the availability of the queried data to the PACS 202. In an embodiment, the PACS 202 may be enabled to receive an acknowledgement from the XDS document registry 204 based on the queried data.

In certain embodiments, the processing engine 214 may be enabled to request manifests or instances of the imaging data associated with one or more patients based on the received acknowledgement from the XDS document registry 204. In an embodiment, the processing engine 214 may be enabled to receive manifests of imaging data associated with one or more patients based on the queried data from the shared document repository, for example, the XDS document repository 206.

In certain embodiments, the shared document repository, for example, the XDS document repository 206 may be populated at least in part by Continuity of Care Documents (CCD) or other clinical summary documents from the Electronic Medical Record (EMR), or by personal health record (PHR) documents. For example, the XDS document repository 206 may include exchanging personal health record (XPHR) content providing common information requested by healthcare providers. Through XPHR, patients may provide a summary of their PHR information to providers, and providers may suggest updates to a patient's PHR after a healthcare encounter. Information from the XDS document repository 206 may be exchanged with a community of one or more physicians or one or more PACS located at other healthcare institutions. For example, information relating to care management, decision support, reporting, imaging, and/or physician signoff may be exchanged.

In certain embodiments, the shared document repository, for example, the XDS document repository 206 may comprise documents, imaging information, and patient related information from other healthcare institutions, where a patient has received healthcare services. In an embodiment, the XDS document repository 206 may communicate manifests or instances of images in a standard format, such as a DICOM format for a plurality of image sets requested by the PACS 202.

In an embodiment, the pre-fetching engine 222 may evaluate and select one or more instances or manifests of images based on a set of selection criteria. The selection criteria may be, for example, one or more of: a modality, a procedure, a body part, and/or a time period. For example, the pre-fetching engine 222 may pre-fetch the imaging data for the previous three months for a particular patient. In an embodiment, the pre-fetching engine 222 may pre-fetch the imaging data for the four most recent exams for a particular modality of the scheduled exam, for example. In another embodiment, the pre-fetching engine 222 may pre-fetch the imaging data for a particular body part, such as the chest of a patient. In another embodiment, the pre-fetching engine 222 may pre-fetch the imaging data for a particular medical procedure.

In another embodiment, the pre-fetching engine 222 may be enabled to pre-fetch imaging information from the shared imaging data repository, for example, the XDS-T image document repository 208 based on the information in the manifests or instances of images received from the XDS document repository 206. The XDS-T image document repository 208 may comprise imaging information, and patient related diagnostic reports from other healthcare institutions, where a patient has received healthcare services. The images stored in the XDS-T image document repository 208 may be stored in a standard format, such as a DICOM format. For example, the PACS 202 may be enabled to pre-fetch imaging information for one or more patients based on a set of selection criteria from the XDS-T image document repository 208 at a configurable time each day. In an embodiment, the PACS 202 may be enabled to pre-fetch imaging information from the XDS-T image document repository 208 for one or more patients that are scheduled for an exam the next day.

In certain embodiments, the image storage repository, for example, the PACS image storage repository 216 may be enabled to store the pre-fetched imaging data. In an embodiment, the PACS image storage repository 216 may comprise a set of local hard disk drives. In another embodiment, the PACS image storage repository 216 may comprise online disk storage such as a redundant array of inexpensive disks (RAID) array.

In certain embodiments, a user, for example, a radiologist may be enabled to access the pre-fetched imaging information stored in the PACS image storage repository 216 via one or more PACS work stations 210. The one or more PACS work stations 210 may be coupled to the PACS 202. For example, if the PACS 202 pre-fetches and stores imaging information for one or more patients that are scheduled for an exam the next day, a radiologist may access the patient's imaging information and other diagnostic reports, which may further reduce wait times for image retrievals and may increase the efficiency of medical professionals.

In another embodiment, a PACS 202 user may query the XDS document registry 204 for desired data regarding one or more patients. The requested patient-related documents may be retrieved from the XDS document repository 206. The PACS 202 user's right to access the patient-related documents may be determined based on the authenticated security context for the user and patient consent attributes associated with the selected documents. If the PACS 202 user is authorized, then the documents may be transmitted for viewing by the user.

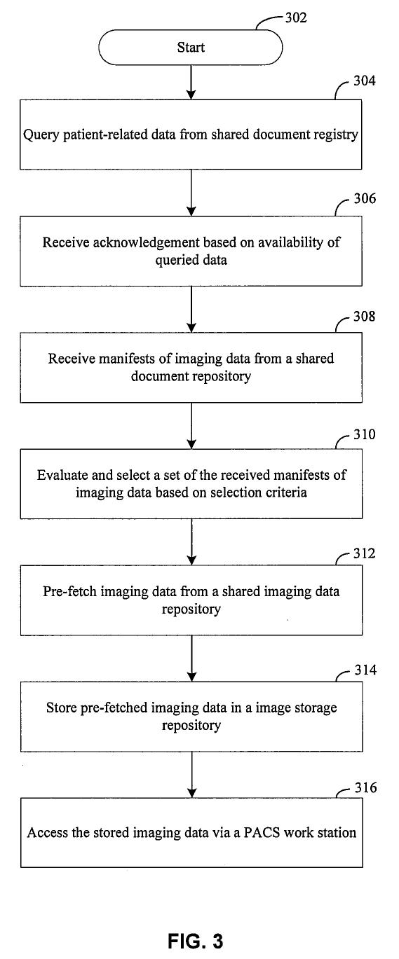

FIG. 3 is a flow chart illustrating exemplary steps for pre-fetching imaging information from multiple healthcare organizations, in accordance with an embodiment of the invention. Referring to FIG. 3, exemplary steps may begin at step 302. In step 304, data associated with one or more patients may be queried from a shared document registry, for example, the XDS document registry 204. In step 306, an acknowledgement may be received from the shared document registry, for example, the XDS document registry 204 based on the availability of the queried data. In step 308, the manifests of imaging data associated with one or more patients may be received from a shared document repository, for example, the XDS document repository 206 based on the queried data.

In step 310, a set of the received manifests of imaging data may be evaluated and selected based on one or more selection criteria. The selection criteria may be one or more of: a modality, a procedure, a body part, and/or a time period. For example, the manifests of imaging information for the previous three months for a particular patient may be selected. In an embodiment, the manifests of imaging information for the four most recent exams for a particular modality of the scheduled exam may be selected, for example. In another embodiment, the manifests of imaging information for a particular body part, such as the chest of a patient may be selected. In another embodiment, the manifests of imaging information for a particular medical procedure may be selected.

In step 312, the selected set of imaging data associated with one or more patients may be pre-fetched from a shared imaging data repository, for example, the XDS-T imaging data repository based on the received manifests of the imaging data. In step 314, the pre-fetched imaging data may be stored in an image storage repository, for example, the PACS image storage repository 216. In step 316, the stored imaging data may be accessed by a user via one or more PACS work stations 210. For example, a radiologist may be enabled to access the pre-fetched and stored imaging information via one or more PACS work stations 210.

One or more of the steps of the method for pre-fetching relevant imaging information from multiple healthcare organizations may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

In accordance with an embodiment of the invention, a method for pre-fetching relevant imaging information from multiple healthcare organizations may comprise querying data associated with one or more patients from a shared document registry, for example, the XDS document registry 204. An acknowledgement may be received from the shared document registry, for example, the XDS document registry 204 based on the availability of the queried data. The data associated with one or more patients may be queried based on one or more selection criteria. The selection criteria may be, for example, one or more of: a modality, a procedure, a body part, and/or a time period. For example, the data associated with one or more patients for the previous three months for a particular patient may be queried. In an embodiment, the data associated with one or more patients for the four most recent exams for a particular modality of the scheduled exam may be queried, for example. In another embodiment, the data associated with one or more patients for a particular body part, such as the chest of a patient may be queried. In another embodiment, the data associated with one or more patients for a particular medical procedure may be queried.

In an embodiment, the manifests of imaging data associated with one or more patients may be requested by the PACS 202 based on the received acknowledgement. The manifests of imaging data associated with one or more patients may be received from a shared document repository, for example, the XDS document repository 206 based on the queried data. A set of the received manifests of imaging data may be selected based on one or more selection criteria. For example, the manifests of imaging information for the previous three months for a particular patient may be selected. In an embodiment, the manifests of imaging information for the four most recent exams for a particular modality of the scheduled exam may be selected, for example. In another embodiment, the manifests of imaging information for a particular body part, such as the chest of a patient may be selected. In another embodiment, the manifests of imaging information for a particular medical procedure may be selected.

The selected set of imaging data associated with one or more patients may be pre-fetched from a shared imaging data repository, for example, the XDS-I imaging data repository 208 based on the received manifests of the imaging data. The imaging data associated with one or more patients may comprise one or more of X-ray images, magnetic reasonance imaging (MRI) data, computer tomography (CT) imaging data, and other medical imaging data. The pre-fetched imaging data may be stored in an image storage repository, for example, the PACS image storage repository 216. The stored imaging data may be accessed by a user via one or more PACS work stations 210.

In accordance with another embodiment, the imaging data associated with one or more patients may be pre-fetched from a shared imaging data repository, for example, the XDS-T imaging data repository based on one or more selection criteria. For example, the imaging data for the previous three months for a particular patient may be pre-fetched. In an embodiment, the imaging data for the four most recent exams for a particular modality of the scheduled exam may be pre-fetched, for example. In another embodiment, the imaging data for a particular body part, such as the chest of a patient may be pre-fetched. In another embodiment, the imaging data for a particular medical procedure may be pre-fetched. The pre-fetched imaging data may be stored in an image storage repository, for example, the PACS image storage repository 216. The stored imaging data may be accessed by a user via one or more PACS work stations 210.

In accordance with an embodiment of the invention, a PACS 202 for pre-fetching relevant imaging information from multiple healthcare organizations may comprise a query engine 220 for querying data associated with one or more patients from a shared document registry, for example, the XDS document registry 204. The PACS 202 may comprise a processing engine 214 for receiving manifests of imaging data associated with one or more patients based on the queried data from the shared document repository, for example, the XDS document repository 206. The PACS 202 may comprise a pre-fetching engine 222 for pre-fetching the imaging data associated with one or more patients from a shared imaging data repository, for example, the XDS-T imaging data repository 208 based on the received manifests of the imaging data.

The PACS 202 may also comprise a shared document interface, for example, the XDS interface 212 for querying the data associated with one or more patients from the shared document registry, for example, the XDS document registry 204. The shared document interface, for example, the XDS interface 212 in combination with the query engine 220 may be enabled to query the data associated with one or more patients based on one or more selection criteria. The selection criteria may include one or more of: a modality, a procedure, a body part, and/or a time period. The shared document interface, for example, the XDS interface 212 in combination with the processing engine 214 may be enabled to receive the manifests of the imaging data associated with one or more patients from the shared document repository, for example, the XDS document repository 206 based on the queried data.

The PACS 202 may also comprise a shared imaging data interface, for example, the XDS-I interface 218 for pre-fetching the imaging data associated with one or more patients from the shared imaging data repository, for example, the XDS-T imaging data repository 208 based on the received manifests of the imaging data. The shared imaging data interface, for example, the XDS-I interface 218 in combination with the pre-fetching engine 222 may be enabled to pre-fetch the imaging data associated with one or more patients from the shared imaging data repository, for example, the XDS-T imaging data repository 208 based on one or more selection criteria. The selection criteria may be, for example, one or more of: a modality, a procedure, a body part, and/or a time period. The PACS 202 may also comprise an image storage repository, for example, the PACS image storage repository 216 for storing the pre-fetched imaging data. The stored imaging data may be accessed by a user via one or more PACS work stations 210.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method for accessing imaging information from one or more healthcare organizations, the method comprising:
querying data associated with one or more patients from a shared document registry;
receiving manifests of imaging data associated with said one or more patients based on said queried data from a shared document repository;
pre-fetching said imaging data associated with said one or more patients from a shared imaging data repository based on said received manifests of said imaging data; and
storing said pre-fetched imaging data in an image storage repository.

2. The method according to claim 1, further comprising querying said data associated with said one or more patients based on one or more selection criteria.

3. The method according to claim 1, further comprising receiving an acknowledgement of said queried data associated with said one or more patients.

4. The method according to claim 3, further comprising requesting said manifests of said imaging data associated with said one or more patients from said shared document repository based on said received acknowledgement.

5. The method according to claim 1, further comprising pre-fetching said imaging data associated with said one or more patients based on one or more selection criteria.

6. The method according to claim 5, wherein said selection criteria comprises one or more of: a modality, a procedure, a body part, and a time period.

7. The method according to claim 1, wherein said imaging data associated with said one or more patients comprises one or more of: X-ray images, magnetic reasonance imaging data, computer tomography imaging data, and medical imaging data.

8. A method for accessing imaging information from one or more healthcare organizations, the method comprising:
pre-fetching imaging data associated with one or more patients from a shared imaging data repository based on one or more selection criteria; and
storing said pre-fetched imaging data in an image storage repository.

9. The method according to claim 8, further comprising querying data associated with said one or more patients from a shared document registry.

10. The method according to claim 9, further comprising receiving manifests of said imaging data associated with said one or more patients based on said queried data from a shared document repository.

11. The method according to claim 8, wherein said imaging data associated with said one or more patients comprises one or more of: X-ray images, magnetic reasonance imaging data, computer tomography imaging data, and medical imaging data.

12. The method according to claim 8, wherein said selection criteria comprises one or more of: a modality, a procedure, a body part, and a time period.

13. A picture archival and communication system for accessing imaging information from one or more healthcare organizations, said system comprising:
a query engine for querying data associated with one or more patients from a shared document registry;
a processing engine for receiving manifests of imaging data associated with said one or more patients based on said queried data from a shared document repository;
a pre-fetching engine for pre-fetching said imaging data associated with said one or more patients from a shared imaging data repository based on said received manifests of said imaging data; and
an image storage repository for storing said pre-fetched imaging data.

14. The system according to claim 13, further comprising a shared document interface for querying said data associated with said one or more patients from said shared document registry.

15. The system according to claim 14, wherein said shared document interface enables querying of said data associated with said one or more patients based on one or more selection criteria.

16. The system according to claim 14, wherein said shared document interface receives said manifests of said imaging data associated with said one or more patients based on said queried data from said shared document repository.

17. The system according to claim 13, further comprising a shared imaging data interface for pre-fetching said imaging data associated with said one or more patients from said shared imaging data repository based on said received manifests of said imaging data.

18. The system according to claim 17, wherein said shared imaging data interface enables pre-fetching of said imaging data associated with said one or more patients from said shared imaging data repository based on one or more selection criteria.

19. The system according to claim 18, wherein said selection criteria comprises one or more of: a modality, a procedure, a body part, and a time period.

20. The system according to claim 13, wherein said imaging data associated with said one or more patients comprises one or more of: X-ray images, magnetic reasonance imaging data, computer tomography imaging data, and medical imaging data.
